(19) United States
(12) Patent Application Publication
(10) Pub. No.: US 2019/0359199 A1
(43) Pub. Date: Nov. 28, 2019

(54) VEHICLE SYSTEM HAVING FUNCTION OF PREVENTING OCCURRENCE FACTORS OF SUDDEN UNINTENDED ACCELERATION

(71) Applicant: STORAGEAN, INC., Seongnam-si (KR)

(72) Inventor: Dong-Gu YOON, Seoul (KR)

(21) Appl. No.: 16/479,757

(22) PCT Filed: Dec. 11, 2017
(86) PCT No.: PCT/KR2017/014494

§ 371 Date: Jul. 22, 2019

(30) Foreign Application Priority Data
Jan. 24, 2017 (KR) 10-2017-0011258
Jan. 24, 2017 (KR) 10-2017-0160572

(51) Int. Cl. B60W 20/13; B60W 10/06; B60W 10/08; B60W 10/26; H01M 8/0606; H01M 16/00; H01M 8/04746; H01M 8/04082

(52) U.S. Cl. CPC B60W 20/13; B60W 10/06; B60W 10/08; B60W 10/26; H01M 8/0606; H01M 16/006; H01M 2250/20; H01M 8/04201; B60W 2710/242; B60W 2710/08; B60Y 2400/434; B60Y 2200/92; H01M 8/04776

(57) ABSTRACT

Provided is an electric vehicle system/general vehicle system having a sudden unintended acceleration prevention function, the system comprising: an auxiliary fuel tank mounted to a vehicle; a hydrogen generation means for receiving fuel from the auxiliary fuel tank so as to generate hydrogen; a stack for receiving hydrogen generated by the hydrogen generation means so as to generate power; a voltage level change unit for changing the voltage level of power generated by the stack; a main battery and an auxiliary battery which are charged by a charging voltage output from the voltage level change unit; a control unit driven by power output from the auxiliary battery; and a drive load unit including a drive motor driven by power output from the main battery or the stack.

### TECHNICAL FIELD

The present invention relates to an electric vehicle system, and more particularly, to an extended-range electric vehicle system capable of improving mileage range associated with a main battery and preventing sudden unintended acceleration upon starting or during travel by heating the interior of a vehicle by means of heat-exchanged air of a combustor and hydrogen generator that receives fuel of an auxiliary fuel tank and by performing control such that the main battery and an auxiliary battery are charged by a stack that receives hydrogen from the combustion and hydrogen generator.

Also, the present invention relates to an electric vehicle system capable of improving mileage range associated with a main battery and preventing sudden unintended acceleration upon starting or during travel by performing control such that the main battery and an auxiliary battery are charged by an external power input means.

Also, the present invention relates to an internal combustion engine-based vehicle system capable of preventing sudden unintended acceleration upon starting or during travel through starting by a main battery and through driving of a control unit by an auxiliary battery by performing control such that the main battery and the auxiliary battery are charged by an internal combustion engine-based power generation means.

### BACKGROUND ART

Fuel cells are considered to be a future power generation technology because they have high power generation efficiency and no emission of pollutants due to power generation compared to conventional power generation methods. Such fuel cells are being actively studied as an environmentally-friendly vehicle driving power source capable of solving an energy saving-associated problem, an environmental pollution problem, and a global warming problem which has recently emerged.

However, when only fuel cells are used in a fuel cell vehicle as a vehicle driving power source, the fuel cells cover all vehicular loads including vehicle interior heating or the like, and thus the driving power performance is degraded in a driving area in which the fuel cells have low efficiency.

Also, a sufficiently high voltage required by a drive motor is not supplied due to an output power characteristic in which the output voltage drops sharply in a high-speed driving area which requires high output power, and thus vehicle acceleration performance is degraded.

Also, when a sudden load is applied to a vehicle, the output voltage of the fuel cells may instantly drop and sufficient power is not supplied to a drive motor, and thus vehicle performance may be degraded. Furthermore, the fuel cells have unidirectional output power characteristics. Therefore, energy drawn from the drive motor when the vehicle is braking cannot be withdrawn, and thus the efficiency of the vehicle system is degraded.

As a solution to the above problem, a hybrid vehicle having a battery charging control system of an electric vehicle has been developed, as disclosed in Korean Patent Publication No. 10-2009-0104171.

Here, the battery charging control system of the conventional electric vehicle includes a high-voltage battery (a main battery), which is an auxiliary driving power source, a fuel cell stack used as a main driving power source, a high-voltage DC/DC converter (HV DC/DC, HDC) which is a bidirectional DC conversion device and which is connected in parallel between the high-voltage battery and fuel cell stack and configured to safely maintain voltage supplied to a drive motor, make a balance between different output voltages of the high-voltage battery and the fuel cell stack, and provide regenerative braking energy and surplus voltage of the fuel cell stack to the high-voltage battery as a charging voltage, a motor control unit (MCU) which is a power module for rotating the drive motor and which is connected to an output end of the high-voltage DC/DC converter and an output end of the fuel cell stack, which is a low voltage source, and configured to receive direct current from the output ends, generate three-phase pulse width modulation (PWM), and control motor driving and regenerative braking, etc. Also, a low-voltage battery (an auxiliary battery) for providing drive power for vehicle electrical equipment is provided along with the high-voltage battery for providing drive power for the drive motor. A low-voltage DC/DC converter (LV DC/DC, LDC) for output power conversion between high voltage and low voltage is connected to the low-voltage battery.

However, for the battery charging control system of the conventional electric vehicle, the drive power for motor driving and regenerative braking is supplied from the output end of the high-voltage DC/DC converter, which is a power module for rotating the drive motor, to a controller or the motor control unit (MCU) of the vehicle during vehicle starting. Thus, a change in voltage level caused by rush current that is generated when drive power is suddenly supplied from the high-voltage battery to the drive motor upon the starting of the vehicle affects the MCU, and this change causes the vehicle to suddenly and unintentionally accelerate or malfunction.

Also, even though the above-described configuration is applied, the vehicle interior heating is performed by the drive power of the fuel cell stack, the high-voltage battery, or the like. Thus, when the vehicle is used in a cold weather area, the consumption of the drive power is increased due to the heating, which cannot overcome drawbacks such as a decrease in mileage range.

### DISCLOSURE

### Technical Problem

The present invention is directed to providing an extended-range electric vehicle system capable of improving mileage range associated with a main battery by heating the interior of an electric vehicle using air heat-exchanged by a combustor and hydrogen generator to which fuel of an auxiliary fuel tank installed in the vehicle is supplied.

The present invention is also directed to providing an extended-range electric vehicle system capable of improving mileage range associated with the main battery by performing control such that a main battery and an auxiliary battery are charged by a stack that receives hydrogen from the combustor and hydrogen generator and capable of preventing sudden unintended acceleration upon starting or during travel by stably supplying operating power from the auxiliary battery to a control unit.

The present invention is also directed to providing an electric vehicle system capable of improving mileage range associated with a main battery and preventing sudden unintended acceleration upon starting or during travel by performing control such that the main battery and an auxiliary battery are charged by an external power input means.

The present invention is also directed to providing an internal combustion engine-based vehicle system capable of preventing sudden unintended acceleration upon starting or during travel through starting by a main battery and through driving of a control unit by an auxiliary battery by performing control such that the main battery and the auxiliary battery are charged by an internal combustion engine-based power generation means.

The present invention is not limited to the above objects, but other objects not described herein may be clearly understood by those skilled in the art from descriptions below.

### Technical Solution

According to the present invention, there is provided an extended-range electric vehicle system including an auxiliary fuel tank installed in a vehicle, a hydrogen generation means configured to receive fuel from the auxiliary fuel tank and generate hydrogen, a stack configured to receive the hydrogen generated by the hydrogen generation means and generate power, a voltage level conversion unit configured to convert a voltage level of the power generated by the stack, a main battery and an auxiliary battery charged with a charging voltage output from the voltage level conversion unit, a control unit driven by power output from the auxiliary battery, and a drive load unit including a drive motor driven by power output from the main battery or the stack, wherein the main battery supplies power for driving various drive loads including the drive motor, and the auxiliary battery supplies power for driving the control unit to prevent sudden unintended acceleration.

Also, according to the present invention, there is provided an electric vehicle system capable of preventing sudden unintended acceleration, the electric vehicle system including a power input unit for charging from an external power source, a voltage level conversion unit configured to convert a voltage level of power input from the power input unit, a main battery and an auxiliary battery charged with a charging voltage output from the voltage level conversion unit, a drive load unit driven by power output from the main battery, and a control unit driven by power output from the auxiliary battery.

Also, according to the present invention, there is provided an internal combustion engine-based vehicle system capable of preventing sudden unintended acceleration, the internal combustion engine-based vehicle system including a fuel tank installed in a vehicle, an internal combustion engine configured to receive fuel from the fuel tank and generate driving power, a power generator and starter motor configured to start the engine and then generate electricity with the driving power of the engine, a voltage level conversion unit configured to convert a voltage level of power generated from the power generator and starter motor, a main battery and an auxiliary battery charged with a charging voltage output from the voltage level conversion unit, a drive load unit driven by power output from the main battery or the power generator and starter motor, and a control unit driven by power output from the auxiliary battery.

### Advantageous Effects

Therefore, according to the present invention, it is possible to improve mileage range associated with a main battery by heating the interior of an electric vehicle using air heat-exchanged by a combustor and hydrogen generator to which fuel of an auxiliary fuel tank installed in the vehicle is supplied so that the main battery is prevented from being used for the heating.

Also, by performing control such that a main battery and an auxiliary battery are charged by a stack that receives hydrogen from a combustor and hydrogen generator, it is possible to improve mileage range associated with the main battery. By operating a control unit using operating power supplied from the auxiliary battery, it is possible to prevent the operating voltage of the control unit operated by the auxiliary battery from being affected by an instantaneous voltage drop of the main battery caused by rush current generated upon starting or during travel. Thus, the control unit may be stably operated to prevent sudden unintended acceleration.

Also, by performing control such that a main battery and an auxiliary battery are charged by an external power input means, it is possible to improve mileage range associated with the main battery and prevent sudden unintended acceleration upon starting or during travel.

Also, by performing control such that a main battery and an auxiliary battery are charged by an internal combustion engine-based power generation means, it is possible to improve mileage range associated with the main battery and prevent sudden unintended acceleration upon starting (activation) or during travel.

The present invention is not limited to the above effects, but other effects not described herein may be clearly understood by those skilled in the art from the accompanying claims.

### DESCRIPTION OF DRAWINGS

FIG. 1 is a block diagram showing a configuration of an electric vehicle system according to a preferred embodiment of the present invention.

FIG. 2 is a sectional view showing a configuration of a combustor and hydrogen generator in the electric vehicle system of FIG. 1 and a power generation and heating system used in the electric vehicle system.

FIG. 3 is a block diagram showing a configuration of a voltage level conversion unit in the electric vehicle system of FIG. 1.

FIG. 4 is a block diagram showing a configuration of an electric vehicle system according to another embodiment of the present invention.

FIG. 5 is a diagram showing a configuration of an internal combustion engine-based vehicle system according to another embodiment of the present invention.

### BEST MODES

Hereinafter, preferred embodiments of the present invention will be described in detail with reference to the accompanying drawings.

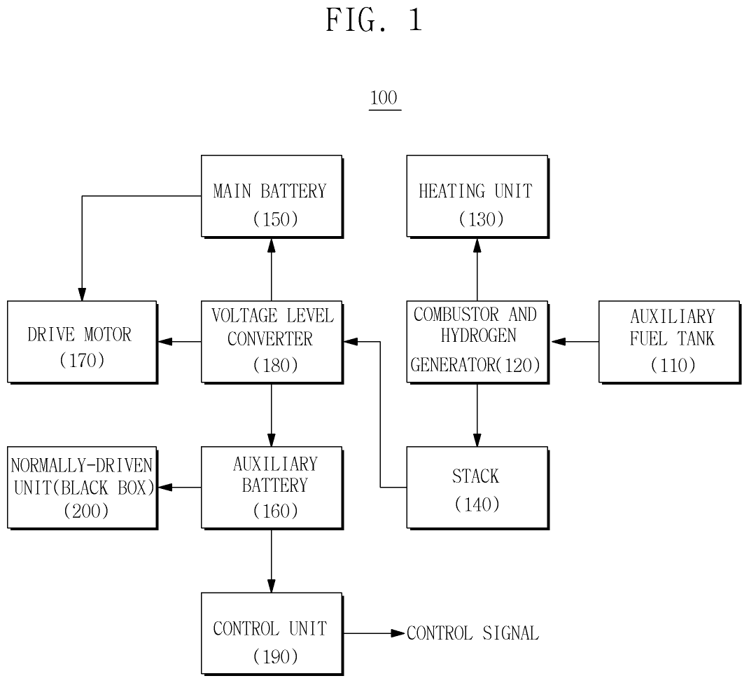

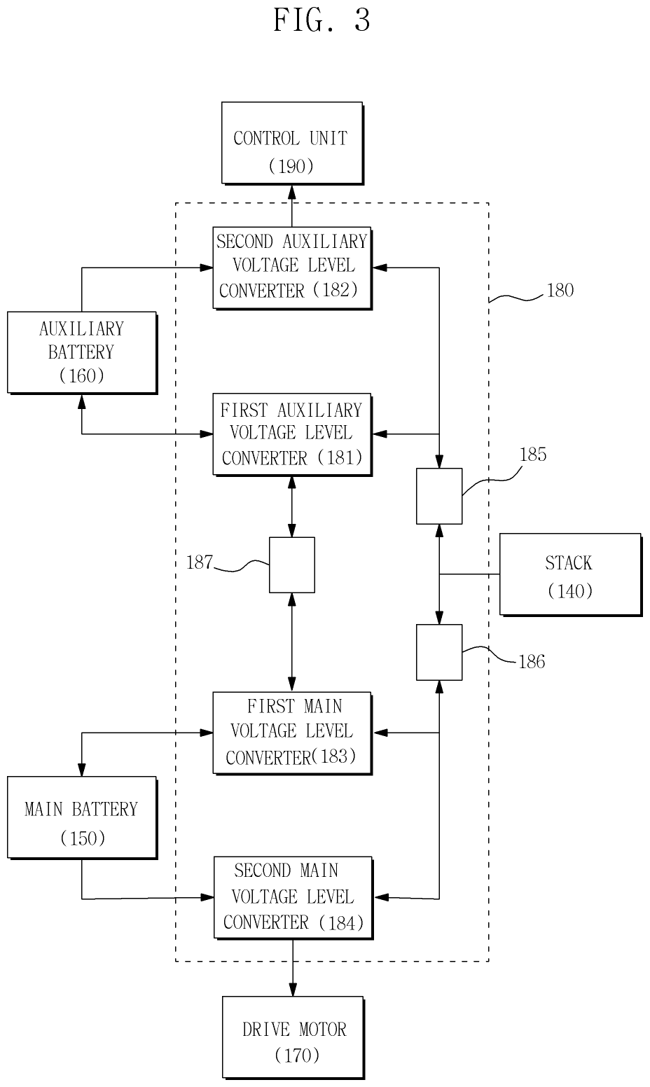

As shown in FIGS. 1 to 3, an electric vehicle system 100 according to a preferred embodiment of the present invention includes an auxiliary fuel tank 110 configured to contain liquefied petroleum gas (LPG), liquefied butane, liquefied methane, or a mixture thereof (hereinafter collectively referred to as LPG), which is easy to thermally decompose, rather than liquefied hydrogen gas, a combustor and hydrogen generator 120 configured to receive the LGP from the auxiliary fuel tank 110, allow air to be heat-exchanged through a combustion-type heat exchange structure, and thermally decompose the LPG to generate hydrogen, a heating unit 130 configured to supply the air heat-exchanged in the combustor and hydrogen generator 120 to the interior of a vehicle and provide a heating function, a stack 140 configured to receive the generated hydrogen from the combustor and hydrogen generator 120 and generate electric energy, a main battery 150 charged with the electric energy generated by the stack 140, an auxiliary battery 160 charged with the electric energy generated by the stack 140, a drive motor 170 configured to receive drive power from any one or at least one of the stack 140 and the main battery 150 and provide a drive function for driving the vehicle, a voltage level conversion unit 180 electrically connected to the stack 140, the main battery 150, the auxiliary battery 160, and the drive motor 170 and configured to perform switching control for electrical connections between the drive motor 170 and the stack 140, between the drive motor 170 and the main battery 150, and between the drive motor 170 and the auxiliary battery 160, between the stack 140 and the main battery 150, and between the stack 140 and the auxiliary battery 160 and for charging of the main battery 150 and the auxiliary battery 160, a control unit 190 operable by receiving operating power from the auxiliary battery 160 through the voltage level conversion unit 180 and configured to control a valve for controlling movement of the LPG supplied to the combustor and hydrogen generator 120, control the heating operation of the heating unit 130, and control the switching of the voltage level conversion unit 180, and the like.

The auxiliary fuel tank 110 is a fuel storage means which is mounted in a trunk of a vehicle or the like and which stores LPG. The auxiliary fuel tank 110 may be designed as an aluminum liner carbon composite tank and may have a storage pressure limit of about 350 bars. The auxiliary fuel tank 110 may have a well-known configuration, and thus a detailed description thereof will be omitted.

The combustor and hydrogen generator 120 includes a combustion unit 120A formed in a corresponding position of the vehicle and configured to receive LPG from the auxiliary fuel tank 110 and allow air to be heat-exchanged through a combustion-type heat exchange structure and a hydrogen generation unit 120B configured to decompose the LPG to generate hydrogen.

The combustion unit 120A includes a fuel inlet 121 through which LPG is injected from the auxiliary fuel tank 110, a combustor 122 having a tubular structure for providing a space where the LPG injected into the fuel inlet 121 is sprayed and then burned by an ignition means (not shown), a heat exchanger 124 connected to an end of the combustor 122 and configured to provide a predetermined space where the combustion heat of the combustor 122 is heat-exchanged with external air and dissipated at a predetermined temperature and configured to maximize heat dissipation through an external heat dissipation fin 124a, a combustion gas outlet 125 formed on an end of the heat exchanger 124 and configured to discharge combustion gas on which heat dissipation is performed to the outside.

Here, it is preferable that the combustor 122 has a Y-shaped cylindrical structure and is separated from an inner reaction tank 127 so that air supplied through an external air injection hole 123a from the outside is sprayed into the combustor 122 through an auxiliary fuel spray hole 123b to burn the LPG.

Also, the hydrogen generation unit 120B includes a fuel nozzle to which LPG is injected from the auxiliary fuel tank 110 and preferably which is formed inside the combustor 122 so that some LPG injected into the fuel inlet 121 is injected to the fuel nozzle, a reaction tank 127 to which the LPG injected to the fuel nozzle 126 is sprayed and preferably which is formed inside the combustor 122 and configured to provide a space where the LPG is heated at a predetermined temperature during the combustion by the combustor 122 and decomposed into carbon and hydrogen, a collection tank 128 connected to an end of the reaction tank 127 and configured to collect the carbon and hydrogen, a cooling water tank 129 configured to receive the carbon and hydrogen through a discharge pipe 129a extending from the collection tank 128, precipitate the carbon in water, and supply the hydrogen to the stack 140 through a hydrogen pipe 129b connected to the stack 140, etc.

Here, fuel decomposition reactions generated inside and outside the reaction tank 127 are as follows.

The combustor 122 outside the reaction tank 127 corresponds to a chemical formula C₃H₈+5O₂→3CO₂+4H₂O.

The inside of the reaction tank 127 corresponds to a chemical formula C₃H₈→3C+4H₂.

A carbon filter CF such as a carbon nano-tube which promotes a reaction in which the fuel, that is, the LPG is decomposed into carbon and hydrogen may be further formed inside the reaction tank 127. In this case, it is preferable that the filter CF is made of an electrically conductive material to have electrical polarity so that the carbon obtained by decomposing the fuel is deposited thereon.

Accordingly, regarding the combustor and hydrogen generator 120, the heat inside the heat exchanger 124 caused by the combustion of the LPG by the combustion unit 120A may allow heat-exchanged air to be supplied into the vehicle through driving of the heat dissipation fin 124a provided outside the heat exchanger 124 and a cooling fan (or an intake fan) (not shown) for increasing heat dissipation. Thus, it is possible to prevent a load for a heating function from being applied to the main battery 150 so that the mileage range associated with the main battery 150 may be improved.

Also, the hydrogen generation unit 120B configured to supply hydrogen to the stack 140 is heated to a predetermined temperature by the combustion unit 120A, and thus the decomposition reaction of the fuel, i.e., LPG may be promoted. Thus, the amount of hydrogen supplied to the stack 140 may be increased, and as a result, it is possible to improve the electricity generation performance of the stack 140.

The heating unit 130 is a means for allowing air having a predetermined temperature to be supplied into the vehicle by causing external air to be heat-exchanged by the combustor 122 or the heat exchanger 124 included in the combustion unit 120A of the combustor and hydrogen generator 120. The heating unit 130 includes an intake fan located on one side of the combustor 122 or the heat exchanger 124 and configured to suction air around the combustor 122 to adjust the amount of air injected into the external air injection hole 123a or cool a cooling fin 124a outside the heat exchanger 124, a duct configured to commumicably connect one side of the combustor or the heat exchanger 124 to a front grille formed inside the vehicle through a separate piping means (not shown) so that the heat-exchanged air is allowed to be injected into the vehicle, etc. The heating unit 130 may be provided as a well-known air-conditioning means including the intake fan, the duct, an air conditioner for controlling the amount of air movement, etc., and thus a detailed description thereof will be omitted.

The stack 140 is an electric energy generation means for receiving the generated hydrogen from the combustor and hydrogen generator 120 and generating electric energy. It is preferable that the stack 140 has a structure in which several to several tens of unit fuel cells, each of which is composed of a membrane electrode assembly (MEA) and a separator, are stacked.

The MEA has a structure in which an anode electrode (a fuel electrode or an oxidation electrode) and a cathode electrode (an air electrode or a reduction electrode) are attached with a polymer electrolyte membrane interposed therebetween, and the separator electrically separates a plurality of MEAs from one another.

Here, the operating principle of the stack 140 will be briefly described as follows.

The MEA includes a polymer electrolyte membrane, a fuel electrode catalyst layer, and an air electrode catalyst layer. In this state, when hydrogen gas or fuel containing hydrogen is supplied to the fuel electrode catalyst layer from the cooling water tank 129 of the combustor and hydrogen generator 120 through the hydrogen pipe 129b, an electrochemical oxidation reaction occurs in the fuel electrode catalyst layer, and the hydrogen is oxidized by being ionized into a hydrogen ion H⁺ and an electron e⁻. Subsequently, the hydrogen ion is moved from the fuel electrode catalyst layer to the air electrode catalyst layer through the polymer electrolyte membrane, and the electron is moved from the fuel electrode catalyst layer to the air electrode catalyst layer through external wires. Subsequently, the hydrogen ion moved into the air electrode catalyst layer generates an electrochemical reduction reaction together with oxygen supplied to the air electrode catalyst layer to generate reaction heat and water. At this time, electric energy is generated by the movement of the electron. The generated water is injected into the cooling water tank 129 of the combustor and hydrogen generator 120 through a water discharge pipe 129c to replenish an amount of cooling water evaporated in the cooling water tank 129 by injection of high-temperature hydrogen gas and fine carbon powder supplied from the collection tank 128.

The main battery 150 is a main charging means in which the electric energy generated by the stack 140 is charged. The main battery 150 may have a well-known configuration such as a lead acid battery, a lithium-ion battery, and a vanadium redox flow battery, and thus a detailed description thereof will be omitted.

The auxiliary battery 160 is an auxiliary charging means in which the electric energy generated by the stack 140 is charged. The auxiliary battery 160 may have a well-known configuration such as a lead acid battery, a lithium-ion battery, and a vanadium redox flow battery, and thus a detailed description thereof will be omitted.

In the present invention, it is preferable that the main battery 150 and the auxiliary battery 160 are grounded by a structure in which ground lines are connected to each other by beads. Thus, it is possible to prevent or mitigate injection of ground line noise induced from various driving units, including the drive motor 170, which are driven by the main battery 150 into ground lines of the control unit 190 and the like driven by the auxiliary battery 160.

The drive motor 170 is a driving means for receiving drive power from any one or at least one of the stack 140 and the main battery 150 and providing a drive function for driving the vehicle. A motor driving method may have a well-known configuration, and a detailed description thereof will be omitted.

The control unit 190 monitors the power of the stack 140, determines whether to drive a driving load unit including the drive motor 170 using the power of the main battery 150 or the output power of the stack 140 depending on the residual quantity of the main battery 150 while the vehicle is traveling, and then supplies the corresponding power to the drive motor 170.

The voltage level conversion unit 180 is a power supply control means that is electrically connected to the stack 140, the main battery 150, the auxiliary battery 160, and the drive motor 170 to operate by a series of switching methods. The voltage level conversion unit 180 performs switching control for electrical connections between the drive motor 170 and the stack 140, between the drive motor 170 and the main battery 150, and between the drive motor 170 and the auxiliary battery 160, for electrical connections between the stack 140 and the main battery 150 and between the stack 140 and the auxiliary battery 160, and for charging of the main battery 150 and the auxiliary battery 160.

To this end, the voltage level conversion unit 180 includes a first auxiliary voltage level converter 181 configured to charge the auxiliary battery 160 with the electric energy of the stack 140, a second auxiliary voltage level converter 182 configured to supply operating power from the auxiliary battery 160 to the control unit 190, a first main voltage level converter 183 configured to charge the main battery 150 with the electric energy of the stack 140, a second main voltage level converter 184 configured to supply operating power from the stack 140 or the main battery 150 to the drive motor 170, a first switch 185 configured to switch between and electrically connect the stack 140 and the first auxiliary voltage level converter 181. a second switch 186 configured to switch between and electrically connect the stack 140 and the first main voltage level converter 183 and configured to switch between and electrically connect the stack 140 and the second main voltage level converter 184, a third switch 187 configured to switch between and electrically connect the first auxiliary voltage level converter 181 and the first main voltage level converter 183, and the like.

Here, the corresponding operation of the voltage level conversion unit 180 is controlled by the control unit 190 to which the operating power is supplied from the auxiliary battery 160 through the second auxiliary voltage level converter 182. This will be described as follows.

First, the output power of the stack 140 is charged with the auxiliary battery 160 by the first auxiliary voltage level converter 181 when the first switch 185 is connected by the control unit 190, and the output power of the stack 140 is charged with the main battery 150 by the first main voltage level converter 183 when the second switch 186 is connected.

Also, the control unit 190 monitors the voltage levels of the main battery 150 and the auxiliary battery 160 and checks charging information, that is, the residual quantities of the batteries. Then, when it is determined that power is being supplied from the stack 140 and the vehicle is traveling, the first switch 185 is switched on so that the auxiliary battery 160 is charged by the first auxiliary voltage level converter 181 and power supplied to the control unit 190 is generated through the second auxiliary voltage level converter 182.

In this state, the second auxiliary voltage level converter 182 may receive the output voltage of the first auxiliary voltage level converter 181 applied to the auxiliary battery as power, instead of using power directly supplied from the stack 140, and then generate power supplied to the control unit 190 depending on how the voltage level conversion unit 180 is designed.

When the vehicle is not traveling, the main battery 150 is charged by power supplied from the stack 140 by the first main voltage level converter 183 while the second switch 186 is connected.

Even though the vehicle is traveling, the state monitoring result of the control unit 190 may show that the drive motor 170 is driven by the power supplied from the stack 140 but the output voltage detected from the stack 140 does not decrease abruptly. In this case, the charging operation is performed on the main battery 150 through the first main voltage level converter 183.

Also, in spite of the above state, it may be determined that the voltage level does not decrease significantly even when the auxiliary battery 160 is charged with the output power of the stack 140 by the control unit 190. In this case, the auxiliary battery 160 is charged with the electric energy of the stack 140 by the first auxiliary voltage level converter 181.

In this case, when the voltage output from the stack 140 drops below a reference value, the control unit 190 may control an auxiliary fuel flow rate control valve to increase the flow rate of auxiliary fuel and increase the amount of hydrogen which is generated to be supplied to the stack 140.

However, alternatively, according to another implementation method, the control unit 190 may supply the power of the stack 140 as the power of the drive load unit including the drive motor 170 and may control the auxiliary fuel flow rate control valve according to a predetermined set value (look-up table) to increase the amount of hydrogen which is generated to be supplied to the stack 140 before attempting the charging operation for the main battery 150 using the power output from the stack 140.

While the vehicle is turned off, the control unit 190 may determine that the power supplied from the stack 140 is cut off. In this case, when it is determined that the difference between the voltage levels of the main battery 150 and the auxiliary battery 160 is greater than or equal to a preset tolerance value, the third switch 187 is switched on so that a battery having a lower voltage level is charged with a battery having a higher voltage level by the first auxiliary voltage level converter 181 and the second auxiliary voltage level converter 182. Subsequently, when it is determined that the difference between the voltage levels of the main battery 150 and the auxiliary battery 160 is less than the preset tolerance value, the third switch 187 is switched off to stop the charging operation between the main battery 150 and the auxiliary battery 160.

Also, while the vehicle is turned off or is not traveling, the power supplied from the stack 140 may be detected. In this case, the control unit 190 allows the auxiliary battery 160 to be charged with the power output from the stack 140 by the first auxiliary voltage level converter 181 and also allows the main battery 150 to be charged with the output power of the stack 140 by the first main voltage level converter 183.

In this case, the control unit 190 determines whether to charge the main battery 150 or the auxiliary battery 160 depending on the residual quantities of the main battery 150 and the auxiliary battery 160 and perform switch control on whether to charge only a corresponding battery with the output power of the stack 140 or whether to turn the first switch 185 and the second switch 186 on so that both of the two batteries are simultaneously charged until the batteries are fully charged.

Accordingly, under the control of the control unit 190, the voltage level conversion unit 180 performs switching control for electrical connections between the drive motor 170 and the stack 140, between the drive motor 170 and the main battery 150, and between the drive motor 170 and the auxiliary battery 160, for electrical connections between the stack 140 and the main battery 150 and between the stack 140 and the auxiliary battery 160, and for charging of the main battery 150 and the auxiliary battery 160.

The control unit 190 is operable by receiving the operating power from the auxiliary battery 160 through the voltage level conversion unit 180. The control unit 190 performs operations such as a valve control mode for the auxiliary fuel flow rate control valve for controlling the movement of the LPG supplied to the combustor and hydrogen generator 120, a heating control mode for controlling the heating operation of the heating unit 130, a charging control mode for controlling the switching of the voltage level conversion unit 180, etc.

Here, since the control unit 190 receives the operating power from the auxiliary battery 160 through the second auxiliary voltage level converter 182 of the voltage level conversion unit 180, rush current that is generated when drive power is suddenly supplied from the main battery 150 to the drive motor 170 upon the starting of the vehicle and also a change in voltage level due to the rush current no longer have any effect. Thus, due to the connection of a ground signal through the above-described beads between the main battery and the auxiliary battery, it is possible to block or suppress injection of ground line noise generated from the drive load unit driven by the main battery as ground line noise at the auxiliary battery side, and it is also possible to prevent the vehicle from suddenly and unintentionally accelerating or malfunctioning.

The valve control mode is a control mode for the auxiliary fuel flow rate control valve for controlling the movement of the LPG supplied to the combustor and hydrogen generator 120. In this mode, the opening and closing of the auxiliary fuel flow rate control valve is controlled to control the amount of movement of the LPG supplied from the auxiliary fuel tank 110 in the combustor and hydrogen generator 120 during operation in the heating control mode or the charging control mode. Thus, it is possible to adjust heating in the hearing control mode and adjust battery charging in the charging control mode.

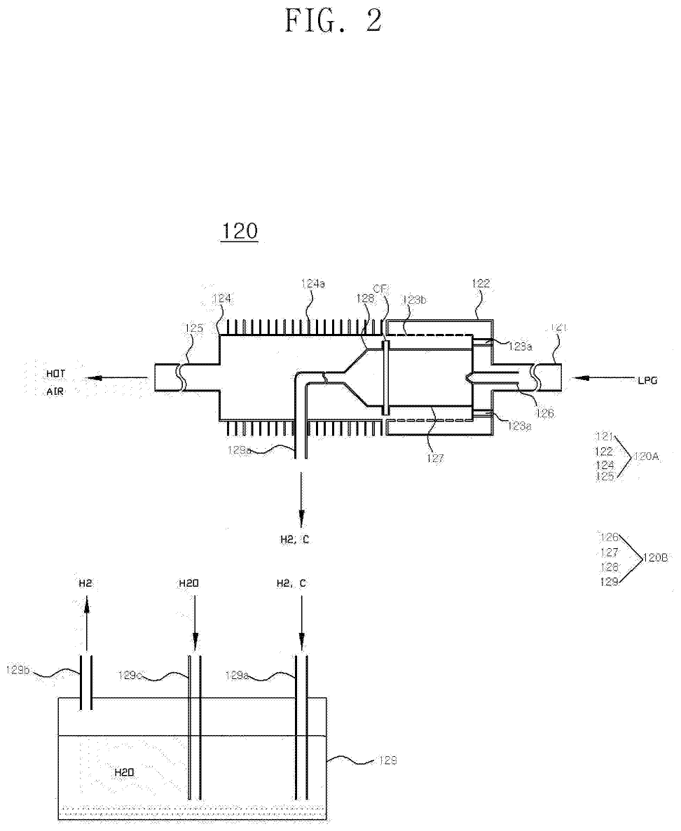

Here, depending on the method of constructing the combustor and hydrogen generator 120 of FIG. 2, only one auxiliary fuel flow rate control valve may be provided at the fuel inlet 121 side, or an auxiliary fuel flow rate control valve dedicated to the combustor 122 and an auxiliary fuel flow rate control valve dedicated to the reaction tank 127 and connected to the nozzle 126 may be separately provided and used to increase the heating and the temperature of the reaction tank 127 or adjust the LPG injected into the reaction tank 127 according to the situation to increase or decrease the amount of hydrogen generation.

The heating control mode is a control mode for providing a heating function by supplying the heat-exchanged air from the combustor and hydrogen generator 120 to the interior of the vehicle in the valve control mode. In this mode, air inside/outside the heat exchanger 124 may be heat-exchanged by the heat exchanger 124 or the combustor 122 included in the combustion unit 120A of the combustor and hydrogen generator 120 and thus air having a predetermined temperature may be supplied into the vehicle.

The charging control mode is a control mode for controlling the switching of the voltage level conversion unit 180, and a control signal operates based on the power supplied from the auxiliary battery 160.

According to the present invention, a sensor unit including a sensor for measuring the concentration of carbon dioxide, an organic compound, dust, etc. in the interior of the vehicle, a sensor for measuring vehicle interior temperature, and the like is connected to the control unit 190 together with a series of intake and exhaust fans. Thus, in addition to the control modes, the control unit 190 may additionally perform an operation corresponding to an air control mode in which a detection of and an alarm and warning about leaked auxiliary fuel are performed and vehicle interior air maintains an air state corresponding to a preset item.

The operation of the electric vehicle system according to the preferred embodiment of the present invention will be described below.

First, the operation of the heating control system of the electric vehicle according to the present invention will be described as follows.

While the movement of LPG of the auxiliary fuel tank 110 supplied to the combustor and hydrogen generator 120 is controlled in the valve control mode, LPG is injected from the auxiliary fuel tank 110 into the fuel inlet 121 of the combustion unit 120A of the combustor and hydrogen generator 120 in the heating control mode by a driver's operation.

Subsequently, the LPG injected into the fuel inlet 121 is sprayed through the auxiliary fuel spray hole 123b provided on an inner wall of the combustor 122, and air supplied from the outside through the external air injection hole 123a provided on one side surface of the combustor 122 is sprayed toward the inside of the combustor 122 and mixed with the fuel. In this state, ignition is achieved by an ignition means (not shown) to burn the LPG.

Subsequently, the combustion heat of the combustor 122 is heat-exchanged with external air through the heat exchanger 124 connected to an end of the combustor 122 and then is dissipated at a predetermined temperature. In this state, the combustion heat is discharged through a combustion gas outlet formed on an end of the heat exchanger 124.

Subsequently, external air injected by an intake fan of a heating unit 130 located on one side of the heat exchanger 124 or the combustor 122 is heat-exchanged with the combustion unit 120A. In this state, the external air is injected into a duct for communicating from the intake fan up to a front grille formed inside the vehicle to provide a heating function to the inside of the vehicle.

Meanwhile, the operation of the battery charge control system of the electric vehicle according to the present invention will be described as follows.

First, while the movement of LPG supplied to the combustor and hydrogen generator 120 is controlled in the valve control mode, LPG is injected from the auxiliary fuel tank 110 into the fuel inlet 121 of the combustion unit 120A of the combustor and hydrogen generator 120 in the heating control mode.

Subsequently, the LPG injected into a fuel inlet 121 is sprayed into a reaction tank 127 through a fuel nozzle 126 and decomposed into carbon and hydrogen due to a high temperature of the reaction tank 127 heated by a combustor 122. In this state, the carbon and hydrogen are collected by a collection tank 128 formed on an end of the reaction tank 127, and then the carbon is precipitated in a cooling water tank 129 extending from the collection tank 128 while the hydrogen is supplied to the stack 140.

In this case, electrodes are formed on left and right sides inside the cooling water tank 129. When the concentration of precipitated carbon increases, a change in current flowing between the electrodes on the left and right sides is converted into a change in voltage, and the control unit 190 senses the change in voltage. Thus, the carbon precipitated at a high concentration in the cooling water tank 129 is discharged to a separate collection box, and then a certain amount of water is replenished.

Meanwhile, the stack 140 receives the hydrogen generated by the combustor and hydrogen generator 120 and generates electric energy.

Subsequently, in the charging control mode, the switching control of the voltage level conversion unit 180 is performed for electrical connections between the drive motor 170 and the stack 140, between the drive motor 170 and the main battery 150, and between the drive motor 170 and the auxiliary battery 160, for electrical connections between the stack 140 and the main battery 150 and between the stack 140 and the auxiliary battery 160, and for charging of the main battery 150 and the auxiliary battery 160.

Accordingly, as described above, by heating the interior of the electric vehicle using air heat-exchanged by the combustor and hydrogen generator 120 to which fuel (LGP) is supplied from the auxiliary fuel tank 110 installed in the vehicle and also by driving a cooling motor of the drive load unit using electricity generated by supplying hydrogen extracted from the fuel in the heated reaction tank 127 to the stack 140, the main battery 150 is only used for the purpose of driving the vehicle as much as possible, and thus it is possible to always guarantee the mileage range corresponding to the proposed specifications of the electric vehicle.

Also, even when the residual quantity of the main battery 150 is not sufficient and a battery charging station is not nearby, a driver is provided with an environment that allows the drive motor 170 to be directly driven by the electricity generated by supplying the hydrogen extracted from the fuel of the auxiliary fuel tank 110 to the stack 140, and thus the driver may maintain mental stability in addition to the extension of the mileage range.

Also, the charging of the main battery 150 and the auxiliary battery 160 is controlled by the stack 140 that receives hydrogen from the combustor and hydrogen generator 120 during traveling, and thus the mileage range associated with the main battery 150 is improved. The control unit 190 is operated by the operating power supplied from the auxiliary battery 160, and thus the control unit 190 driven by the auxiliary battery 160 does not malfunction despite ground line noise and an instantaneous voltage drop at a main battery output stage caused by rush current generated upon starting or during travel. Accordingly, it is possible to prevent sudden unintended acceleration.

Also, when a normally-driven unit 200 requiring normal driving, such as a vehicular black box, is activated for a long time although the vehicle is turned off, the device is driven by a power source which is switched from the main battery 150 to the auxiliary battery 160. Thus, it is possible to prevent the main battery 150 from dying due to the normally-driven unit 200. Accordingly, when the residual quantity of the auxiliary battery 160 drops to a certain level or less, the auxiliary battery 160 is automatically recharged by electricity generated by activating the combustor and hydrogen generator 120 using the fuel contained in the auxiliary fuel tank 110. Also, even when the battery is dead due to long-term non-operation of the vehicle, the main battery 150 may be always maintained in a slowly and fully charged state by electricity which is generated by activating the combustor and hydrogen generator 120 in the same manner under the control of the control unit 190.

When one of the main battery 150 and the auxiliary battery 160 is monitored as having a residual quantity less than or equal to a tolerable reference value due to long-term non-operation of the vehicle, the control unit 190 may control the auxiliary fuel flow rate control valve and the combustor and hydrogen generator 120 to generate hydrogen, and the charging operation may be performed on the corresponding battery having the residual quantity less than or equal to the tolerable reference value or performed on both of the main battery and the auxiliary battery by power that is output from the stack 140 while the hydrogen generated by the combustor and hydrogen generator 120 is supplied to the stack 140.

Last, even though a driver is tired due to long-distance driving but should charge the vehicle through a charger for the purpose of the next day's operation of the vehicle, the charging may not be possible because the situation is not favorable. In this case, by activating the combustor and hydrogen generator 120 at a weak level for a long time, the battery is slowly charged, and also the interior of the vehicle is maintained in a weak heating state during winter. Thus, snow is not piled on the front windshield despite snowy weather, thereby providing an environment that allows the vehicle to travel immediately.

In the electric vehicle system 100 according to the preferred embodiment of the present invention, the main battery 150, the auxiliary battery 160, the drive motor 170, and the control unit 190 are connected to and operably controlled by the stack 140 configured to receive the hydrogen from the auxiliary fuel tank 110 that contains LPG, liquefied butane, liquefied methane, or a mixture thereof (hereinafter collectively referred to as LPG), which is easy to thermally decompose, rather than liquefied hydrogen gas.

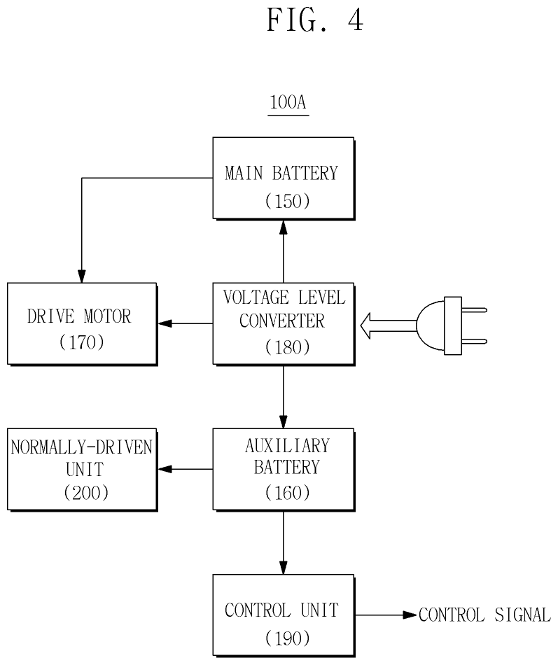

However, as shown in FIG. 4, an electric vehicle system 100A according to another embodiment of the present invention may have a main battery 150, an auxiliary battery 160, a drive motor 170, and a control unit 190 connected to and operably controlled by an external power source through a power input unit.

The electric vehicle system 100A according to another embodiment of the present invention includes a power input unit for charging from an external power source, a voltage level conversion unit 180 configured to convert the voltage level of power input from the power input unit, a main battery 150 and an auxiliary battery 160 charged with a charging voltage output from the voltage level conversion unit, a control unit 190 driven by power output from the auxiliary battery, and a drive load unit including a drive motor 170 driven by power output from the main battery 150.

Even in the electric vehicle system 100A according to another embodiment of the present invention, it is preferable that ground lines between the main battery and the auxiliary battery are not connected to each other directly but by additionally provided beads so that ground line noise at the drive load side which is driven by the main battery does not affect a ground signal level of a ground line at the control unit side which is driven by the auxiliary battery.

Also, it is preferable that a normally-driven unit 200 driven by the output power of the auxiliary battery is additionally provided.

Also, the control unit monitors a voltage level output from the auxiliary battery and checks the residual quantity. When the residual quantity of the auxiliary battery drops below a reference value because of a normally-driven load unit driven by the output power of the auxiliary battery, the control unit blocks power supplied from the auxiliary battery to the normally-driven load unit in order to start the vehicle.

Also, when the result of the control unit monitoring the voltage level output from the auxiliary battery and checking the residual quantity is that the output voltage of the auxiliary battery is a preset charging-required residual value which is not sufficient even to drive the control unit in the future, the control unit charges the auxiliary battery using the main battery until the residual quantity of the auxiliary battery reaches a certain level.

Also, when the result of the control unit monitoring the voltage level output from the auxiliary battery and checking the residual quantity is that the output voltage of the auxiliary battery is a preset charging-required residual value which is not sufficient even to drive the control unit in the future, the control unit drives a power generator and starter motor while the power of the main battery, instead of that of the auxiliary battery, is supplied to the control unit upon the starting of the vehicle.

In the electric vehicle system 100 according to the preferred embodiment of the present invention, the main battery 150, the auxiliary battery 160, the drive motor 170, and the control unit 190 are connected to and operably controlled by the stack 140 configured to receive the hydrogen from the auxiliary fuel tank 110 that contains LPG, liquefied butane, liquefied methane, or a mixture thereof (hereinafter collectively referred to as LPG), which is easy to thermally decompose, rather than liquefied hydrogen gas.

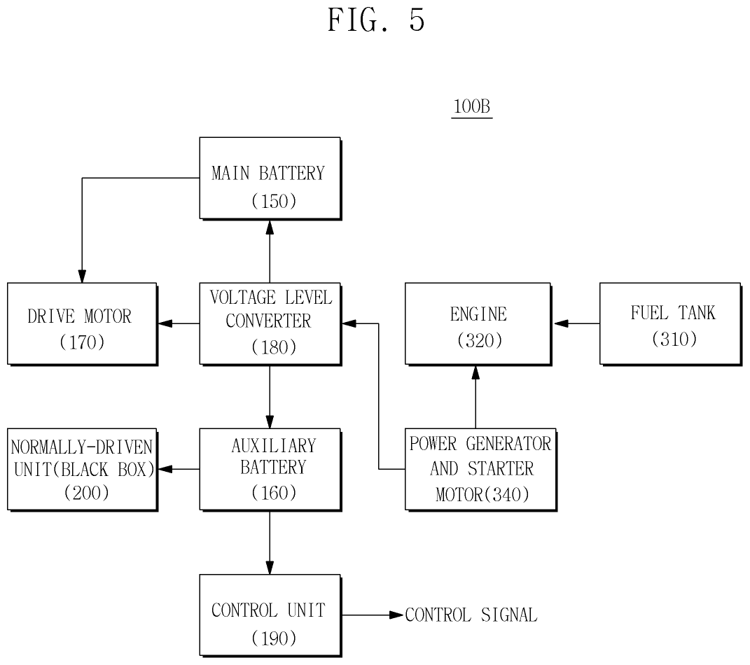

However, as shown in FIG. 5, an internal combustion engine-based vehicle system 100B according to another embodiment of the present invention may have a main battery 150, an auxiliary battery 160, a drive motor 170, and a control unit 190 connected to and operably controlled by a power generator and starter motor 340 connected to an internal combustion engine 3210 that receives fuel.

The internal combustion engine-based vehicle system 100B according to another embodiment of the present invention includes a fuel tank 310 installed in a vehicle, an engine 320 configured to receive fuel from the fuel tank 310 and generate driving power, a power generator and starter motor 340 configured to start the engine 320 and then generate electricity with the driving power of the engine 320, a voltage level conversion unit 180 configured to convert the voltage level of power generated from the power generator and starter motor 340, a main battery 150 and an auxiliary battery 160 charged with a charging voltage output from the voltage level conversion unit 180, a control unit 190 driven by power output from the auxiliary battery 160, and a drive load unit including a drive motor 170 driven by power output from the main battery 150 or the power generator and starter motor 340.

Even in this case, it is preferable that ground lines between the main battery 150 and the auxiliary battery 160 are not connected to each other directly but by additionally provided beads so that ground line noise at the drive load unit side which is driven by the main battery 150 does not affect a ground signal level of a ground line at the control unit 190 side which is driven by the auxiliary battery 160.

Also, the electric vehicle system 100B according to another embodiment of the present invention may further include a normally-driven unit 200 driven by the output power of the auxiliary battery 160.

The control unit 190 monitors a voltage level output from the auxiliary battery 160 and checks a residual quantity thereof. When the residual quantity of the auxiliary battery 160 drops below a reference value by the normally-driven unit 200 driven by the output power of the auxiliary battery 160, the control unit 190 blocks power supplied from the auxiliary battery 160 to the normally-driven unit 200 in order to start the vehicle.

Also, when the result of the control unit 190 monitoring the voltage level output from the auxiliary battery 160 and checking the residual quantity is that the output voltage of the auxiliary battery 160 is confirmed to be a preset charging-required residual value which is not sufficient even to drive the control unit 190 in the future, the control unit 190 charges the auxiliary battery 160 using the main battery 150 until the residual quantity of the auxiliary battery 160 reaches a certain level.

Also, when the result of the control unit 190 monitoring the voltage level output from the auxiliary battery 160 and checking the residual quantity is that the output voltage of the auxiliary battery 160 is confirmed to be a preset charging-required residual value which is not sufficient even to drive the control unit 190 in the future, the control unit 190 drives the power generator and starter motor 340 while the power of the main battery 150, instead of that of the auxiliary battery, is supplied to the control unit 190 upon the starting of the vehicle.

Consequently, according to the above description, there may be provided the internal combustion engine-based vehicle system having the main battery, the auxiliary battery, the drive motor, and the control unit connected to and operably controlled by the power generator and starter motor connected to an engine that receives fuel.

According to the present invention, the stack 140 may receive hydrogen, and the main battery 150 and the auxiliary battery 160 may be charged. However, according to another embodiment of the present invention, there may be provided a power generation heater system configured to perform heating by air heat-exchanged in the combustor configured to perform a combustion operation using oxygen in the air and fuel supplied from the fuel tank and configured to charge the battery by the stack that receives hydrogen obtained through decomposition by the heat of the combustor.

To this end, the power generation heater system according to the present invention includes a fuel tank 110, a combustor 122 configured to perform a combustion operation with fuel supplied from the fuel tank and oxygen in the air, a reaction tank 127 located inside the combustor and configured to thermally decompose the fuel supplied from the fuel tank by heat of the combustion unit to generate hydrogen, a stack 140 configured to receive the generated hydrogen from the reaction tank and generate power, a voltage level conversion unit 180 configured to convert the voltage level of the power generated by the stack, and a battery 150 or 160 charged with a charging voltage output from the voltage level conversion unit.

Here, it is preferable that the power generation heater system of the present invention may additionally include a fuel flow rate control valve for controlling the flow rate of the fuel between the fuel tank 110 and the combustor 122 and between the fuel tank 110 and the reaction tank 127 and the fuel contained in the fuel tank 110 is LPG, liquefied butane, liquefied methane, or a mixture thereof, which is easy to thermally decompose.

Also, the power generation heater system of the present invention includes a reaction tank 127 where the fuel injected from the fuel tank is thermally decomposed and a combustor 122 configured to receive fuel from the fuel tank 110 and formed to surround an outer wall of the reaction tank 127 while having a combustion space with a certain width disposed between the combustor 122 and the reaction tank 127.

Here, the combustor 122 includes a series of fuel spray holes 123b disposed on a surface adjacent to the reaction tank 127 and also an external air injection hole 123a disposed on one surface of the fuel inlet 121 to allow external air to be injected so that the reaction tank 127 is heated by the combustion operation occurring in the space between the reaction tank 127 and the combustor 122.

The reaction tank 127 additionally has a fuel spray nozzle 126 disposed on the fuel inlet 121 side and configured to allow the fuel injected to the reaction tank to be sprayed into the reaction tank and prevent products obtained through thermal decomposition from flowing back to the fuel inlet side while the fuel is decomposed into hydrogen and carbon by heat generated from the combustor, and includes a collection tank 128 disposed on a side opposite to the fuel inlet and configured to collect the hydrogen and carbon obtained through the thermal decomposition.

A carbon filter CF is additionally provided between the reaction tank 127 and the collection tank 128 to promote the thermal decomposition reaction.

Also, the power generation heater system of the present invention has a heat exchanger 124 coupled to the combustor 122 so that the reaction tank 127 and the collection tank 128 are built therein, the heat exchanger 124 having a series of heat dissipation fins 124a disposed on an outer surface to facilitate heat exchange between the combustion heat of the combustor 122 and external air and having an outlet 125 disposed on a longitudinal side opposite to the combustor 122 to discharge combustion gas of the combustor 122.

The present invention includes a heating unit 130 including a heat dissipation fan (not shown) configured to promote heat exchange at the outside of the heat exchanger and a sensor unit (not shown) configured to detect whether gas leaks from the heat exchanger 124 or the combustor 122.

Here, the sensor unit further includes a control unit 190 and is provided as one of, or a combination of, a fuel leak sensor, a carbon dioxide concentration sensor, and a temperature sensor. The control unit 190 performs control associated with the fuel flow rate control valve according to the detection result of the sensor unit.

Also, the present invention further includes a cooling water tank 129 for cooling high-temperature hydrogen injected from the collection tank, discharging the hydrogen at low temperature, and precipitating high-temperature carbon in water.

Accordingly, according to another embodiment of the present invention, there may be provided a power generation heater system configured to perform heating by air heat-exchanged in the combustor 122 configured to perform a combustion operation using oxygen in the air and fuel supplied from the fuel tank 110 and configured to charge the battery 150 or 160 by the stack 140 that receives hydrogen obtained through decomposition by the heat of the combustor.

While the present invention has been described with reference to the specific embodiments, various changes and modifications may be made without departing from the scope of the present invention. Accordingly, the scope of the present invention is not to be determined by the described embodiments but should be determined by the claims and their equivalents.

1. An extended-range electric vehicle system comprising:
an auxiliary fuel tank installed in a vehicle;
a hydrogen generation means configured to receive fuel from the auxiliary fuel tank and generate hydrogen;
a stack configured to receive the hydrogen generated by the hydrogen generation means and generate power;
a voltage level conversion unit configured to convert a voltage level of the power generated by the stack;
a main battery and an auxiliary battery charged with a charging voltage output from the voltage level conversion unit;
a control unit driven by power output from the auxiliary battery; and
a drive load unit including a drive motor driven by power output from the main battery or the stack,
wherein,
the main battery supplies power for driving various drive loads including the drive motor, and
the auxiliary battery supplies power for driving the control unit to prevent sudden unintended acceleration.

2. The extended-range electric vehicle system of claim 1, wherein ground lines between the main battery and the auxiliary battery are not connected to each other directly but by additionally provided beads so that ground line noise at a drive load side which is driven by the main battery does not affect a ground signal level of a ground line at a control unit side which is driven by the auxiliary battery.

3. The extended-range electric vehicle system of claim 1, further comprising an auxiliary fuel flow rate control valve disposed between the auxiliary fuel tank and the hydrogen generation means and configured to control a flow rate of auxiliary fuel, wherein the auxiliary fuel flow rate control valve is controlled by the control unit.

4. The extended-range electric vehicle system of claim 1, wherein the fuel contained in the auxiliary fuel tank is not liquefied hydrogen gas but liquefied petroleum gas, liquefied butane, liquefied methane, or a mixture thereof, which is easy to thermally decompose.

5. The extended-range electric vehicle system of claim 4, wherein the hydrogen generation means comprises a reaction tank where fuel injected from the auxiliary fuel tank is thermally decomposed and a combustor configured to receive fuel from the auxiliary fuel tank and formed to surround an outer wall of the reaction tank while having a combustion space with a predetermined width disposed between the reaction tank and the combustor.

6. The extended-range electric vehicle system of claim 5, wherein the combustor comprises a series of fuel spray holes disposed on a surface adjacent to the reaction tank and an external air injection hole disposed on a fuel inlet surface to allow external air to be injected so that the reaction tank is heated by a combustion operation that occurs in a space between the reaction tank and the combustor.

7. The extended-range electric vehicle system of claim 5, wherein the reaction tank comprises a fuel spray nozzle disposed on a side corresponding to a fuel inlet and configured to allow the fuel injected to the reaction tank to be sprayed into the reaction tank and prevent products obtained through thermal decomposition from flowing back to the fuel inlet side while the fuel is decomposed into hydrogen and carbon by heat generated from the combustor, and comprises a collection tank disposed on a side opposite to the fuel inlet and configured to collect the hydrogen and carbon obtained through the thermal decomposition.

8. The extended-range electric vehicle system of claim 7, further comprising a carbon filter disposed between the reaction tank and the collection tank and configured to promote a thermal decomposition reaction.

9. The extended-range electric vehicle system of claim 7, further comprising a heat exchanger coupled to the combustor so that the reaction tank and the collection tank are built therein, the heat exchanger having a series of heat dissipation fins disposed on an outer surface to facilitate heat exchange between combustion heat of the combustor and external air and an outlet disposed on a longitudinal side opposite to the combustor to discharge combustion gas of the combustor.

10. The extended-range electric vehicle system of claim 9, wherein the heat exchanger comprises:
a heat dissipation fan configured to promote heat exchange at an outside thereof;
a pipe configured to transfer heat of an external surface of the heat exchanger to another side of the vehicle; and
a heating unit including a sensor unit configured to detect an abnormality of the heat exchanger or the pipe.

11. The extended-range electric vehicle system of claim 10, wherein the sensor unit is provided as one of, or a combination of, a fuel leak sensor, a carbon dioxide concentration sensor, and a temperature sensor, and the control unit performs control associated with a ventilation fan or an auxiliary fuel flow rate control valve included in the drive load unit according to a result of the detection by the sensor unit.

12. The extended-range electric vehicle system of claim 7, further comprising a cooling water tank configured to cool high-temperature hydrogen injected from the collection tank, discharge the hydrogen at low temperature, and precipitate high-temperature carbon in water.

13. The extended-range electric vehicle system of claim 12, wherein in order to maintain the water of the cooling water tank, which is evaporable by the high-temperature hydrogen and carbon injected from the collection tank at a certain level, the evaporated water of the cooling water is replenished with water generated during operation of the stack.

14. The extended-range electric vehicle system of claim 12, wherein the cooling water tank has electrodes on one side wall and the other side wall, converts the amount of change in current flowing between the electrodes into the amount of voltage according to the amount of precipitated carbon so that the control unit recognizes the amount of precipitated carbon, issues a notification to replace the precipitated carbon with fresh water when it is determined that the amount of precipitated carbon is greater than or equal to a certain preset level.

15. The extended-range electric vehicle system of claim 1, wherein the voltage level conversion unit receives power output from the stack according to control of the control unit and converts the output power into a voltage for charging the main battery or the auxiliary battery.

16. The extended-range electric vehicle system of claim 1, wherein the control unit monitors output voltages of the main battery and the auxiliary battery to check residual quantities of the batteries and monitors the output power of the stack to drive the drive load unit, charge the main battery, charge the auxiliary battery or determine whether to use the auxiliary battery or the output power of the stack as power for driving the control unit.

17. The extended-range electric vehicle system of claim 16, wherein the control unit monitors the power of the stack, determines whether to charge the main battery or the auxiliary battery according to the residual quantities of the main battery and the auxiliary battery when the vehicle is turned off or is not traveling, and only charges a corresponding battery with the output power of the stack or simultaneously charges the two batteries until the batteries are fully charged.

18. The extended-range electric vehicle system of claim 3, wherein when one of the batteries is monitored as having a residual quantity less than a tolerable reference value due to long-term non-operation of the vehicle, the control unit controls the auxiliary fuel flow rate control valve and the hydrogen generation means to generate hydrogen, supplies the hydrogen generated by the hydrogen generation means to the stack, and then performs a charging operation for the battery having the residual quantity less than the tolerable reference value or both of the main battery and the auxiliary battery using power output from the stack.

19. The extended-range electric vehicle system of claim 17, wherein the control unit monitors the power of the stack, determines whether to operate with the power of the auxiliary battery or the power of the stack depending on the residual quantity of the auxiliary battery when it is determined that the vehicle is not traveling and a normally-driven system such as a vehicle black box is turned on, and switches a corresponding switch.

20. The extended-range electric vehicle system of claim 19, wherein when the residual quantity of the auxiliary battery is less than or equal to a preset reference value while the normally-driven system is operated by the power of the stack, the control unit controls an auxiliary fuel flow rate control valve and the hydrogen generation means to generate hydrogen, supplies the hydrogen generated by the hydrogen generation means to the stack, and then charges the normally-driven system and the auxiliary battery with the power output from the stack.

21. The extended-range electric vehicle system of claim 16, wherein the control unit monitors the power of the stack, determines whether to drive the drive load unit including the drive motor using the power of the main battery or the output power of the stack depending on the residual quantity of the main battery when the vehicle is traveling, and switches a switch for corresponding power.

22. The extended-range electric vehicle system of claim 21, wherein when it is determined that the output voltage of the stack does not drop rapidly even though the control unit attempts to charge the main battery with the power of the stack while supplying the power of the stack as the power of the drive load unit including the drive motor, the control unit simultaneously supplies power for driving the drive load unit and power for charging the main battery.

23. The extended-range electric vehicle system of claim 21, wherein when it is monitored that the output voltage of the stack drops rapidly after the control unit attempts to charge the main battery with the power of the stack while supplying the power of the stack as the power of the drive load unit including the drive motor, the control unit controls an auxiliary fuel flow rate control valve to increase a flow rate of auxiliary fuel and thus increase the amount of generation of hydrogen to be supplied to the stack.

24. The extended-range electric vehicle system of claim 21, wherein before the control unit attempts to charge the main battery with the power of the stack while supplying the power of the stack as the power of the drive load unit including the drive motor, the control unit controls an auxiliary fuel flow rate control valve by a preset value to increase a flow rate of auxiliary fuel and thus increase the amount of generation of hydrogen to be supplied to the stack.

25. The extended-range electric vehicle system of claim 16, wherein when the vehicle is not traveling, the control unit monitors the output voltages of the main battery and the auxiliary battery and charges the battery having the lower output voltage using the battery having the higher output voltage.

26. The extended-range electric vehicle system of claim 1, wherein the voltage level conversion unit comprises:
a first auxiliary voltage level converter configured to charge the auxiliary battery with the output power of the stack;
a second auxiliary voltage level converter configured to supply operating power from the auxiliary battery to the control unit;
a first main voltage level converter configured to charge the main battery with the power of the stack;
a second main voltage level converter configured to supply operating power from the stack or the main battery to the drive load unit including the drive motor;
a first switch configured to switch between the stack and the first auxiliary voltage level converter to electrically conduct with each other;
a second switch configured to switch between the stack and the first main voltage level converter and between the stack and the second main voltage level converter to electrically conduct with each other; and
a third switch configured to switch between the first auxiliary voltage level converter and the first main voltage level converter to electrically conduct with each other.

27.-38. (canceled)
